(19) United States
(12) Patent Application Publication
(10) Pub. No.: US 2013/0234426 A1
(43) Pub. Date: Sep. 12, 2013

(54) VALVE DOCUMENT HAVING AN AT LEAST PARTIALLY EMBEDDED SECURITY ELEMENT

(71) Applicants: Matthias Müller, Bechstrieth (DE); Christoph Kocher, Landquart (CH); Jakob Grob, Mastrils (CH)

(72) Inventors: Matthias Müller, Bechstrieth (DE); Christoph Kocher, Landquart (CH); Jakob Grob, Mastrils (CH)

(21) Appl. No.: 13/817,203

(22) PCT Filed: Aug. 22, 2011
(86) PCT No.: PCT/EP11/04216

§ 371 Date: May 28, 2013

(30) Foreign Application Priority Data
Aug. 27, 2010 (AT) A 1441/2010

(51) Int. Cl. B42D 15/00

(52) U.S. Cl. CPC B42D 15/0013; B42D 15/0086
USPC 283/82; 283/72; 283/83; 156/60; 156/244.12; 156/272.2

(57) ABSTRACT

The invention relates to a value document having an at least partially embedded security element, wherein the value document consists of a security paper having two or more layers of identical or different materials, and wherein the security element is designed as a transfer element and is applied to an internal surface of one of the layers of the security paper and is at least partially covered by at least one further layer of the multilayer security paper.

### TECHNICAL FIELD

The invention relates to an in particular two- or muitilayer value document, for example a banknote, a security, or an identity document having an embedded security element in the form of a transfer element.

### PRIOR ART

Two- or multilayer value documents are generally produced from laminates or composites which comprise layers of different materials.

In particular, combinations of paper and plastic in a laminate find manifold uses, since such a laminate increases the resistance of paper, and in particular has improved tear strength, resistance to soiling and the like.

Thus, for example EP 1 599 346 B, discloses a multilayer laminate which is usable as a security paper, and has an optionally multilayer plastic layer having a top side and a bottom side and at least one paper layer on the top side of the plastic layer, which paper layer is bonded to the plastic layer. On the bottom side of the plastic layer, likewise, one paper layer can be situated. At least in one of the paper layers and/or in the plastic layer, in this case, a security feature can be incorporated in the form of an electrical, electronic, magnetic or optical information medium, or a combination thereof. Examples thereof are watermarks, imprints, microperforations, iridescent colors, colored fibers or the like.

The security paper in this case has an appearance and feel of paper, but has a markedly higher tear strength and stability than paper.

WO 2004/028825 A discloses a security paper for producing value documents such as banknotes and the like, which consists of a crumplable multilayer substrate comprising at least one paper layer and at least one foil.

Security features can be applied to the paper layer, for example in the form of an imprint, but also in the form of optically variable elements. The paper surface is then provided on one or both sides with a plastic film for increasing soiling resistance. In addition, a security thread can be at least partially embedded into the paper layer or be arranged between the paper layer and the plastic film.

WO 2005/038135 A discloses a multilayer security paper which consists of at least two paper layers, wherein one of the paper layers comprises at least one security element.

The embedding of security elements such as, for example, security threads into multilayer security papers, proves to be difficult. The multilayer security papers consist of two or more layers of usually different materials having different properties, for example paper and plastic layers. The individual layers have a correspondingly lower thickness than the thickness of a single-layer security paper.

Security elements such as, for example, security threads can be equipped with numerous security features such as, for example, color-shifting effects, fluorescence effects, electrically conductive properties, magnetic properties, magnetic codes and the like.

The security features may be combined virtually as desired, but in general the thickness of the security element thereby increases.

A security thread, according to the prior art, is understood to be a structure which comprises at least one film-type carrier substrate (for example a plastic film), onto which, or into which, security features are applied or introduced, wherein the security features are optionally protected by a further film-type carrier substrate. Such security threads have been in use worldwide in conventional security papers for a long time and in most currencies. Owing to the thickness of the film-type carrier substrate which must ensure sufficient stability in the production and processing process and also sufficient stability in circulation of the value document, the thickness of such security threads is generally between 23 and 45 μm.

WO 2006/066431 A discloses that security threads can be incorporated into a multilayer security printing substrate consisting of two thin security paper layers and one internal polymer layer, which security threads come to lie between a security paper layer and the internal polymer layer. The thickness of the security thread contributes at least partly to the overall thickness of the printing substrate in this case.

Security threads are generally finished on their surface on both sides with an adhesive, which is intended to ensure firm anchoring in the value document. This is usually a heat-sealing adhesive which is activated during paper production. In the case of a short heat exposure period, the heat exposure time is frequently insufficient to activate the heat-sealing adhesive on the security thread to the extent that good anchoring is achieved. This applies, in particular, to the side of the security thread which comes to lie on the paper layer.

Generally, a single-layer security paper has a weight per unit area of 80-110 g/m² at a thickness of about 80 to 130 μm. A single paper layer of a multilayer security paper typically has a weight per unit area of typically 35 g/m² and a thickness of about 35 to 50 μm, and the thickness of an internal plastic layer is typically 30 to 40 μm at a weight per unit area of likewise 30 to 40 g/m². With a multilayer security paper having an internal paper layer and external plastic layers, the weight per unit area of the paper layer is typically 80 to 100 g/m² and the thickness of the plastic layers typically 4 to 12 μm. Security threads generally—as mentioned above—have a thickness of about 23 to 45 μm and can therefore only be anchored into the thin layers of the security paper with difficulty. They have only little adhesion in the relevant layer and even emerge out of this layer, since the paper fibers cannot completely cover the security thread.

Nevertheless, if an attempt is made to incorporate a security thread into a paper, wherein both the paper layer and the security thread are of similar thickness, and if then a paper web is wound up to form a relatively large roll, the local thickness difference at the point of the embedded security thread is reinforced in each additional winding. In technical language, this effect is frequently named “piston ring”. In extreme cases, this partial overstretching, blockages (owing to the locally higher pressure) or tearing can even occur. The effect of the additional application due to thick security threads becomes still more noticeable when a number of sheets are stacked one above the other. Owing to the threads lying one above the other, the sheet stack becomes wavy, which can make further processing very difficult. This is usually counteracted by security threads being oscillated during introduction into the security paper in such a manner that they do not lie exactly one above the other in the stack, but come to lie distributed over a width range of, for example, 6 mm.

An important disadvantage of this method is that integration of the security thread into the remaining design of the value document is impossible. This is disruptive, in particular, when the position of the security thread is intended to be in a defined relation to a viewing window or else to a single-sided opening in a multi-layer value document. For example, it can be desirable to have a security thread run through a viewing window of a multilayer value document, wherein the security thread is intended to run exactly through the middle of the viewing window in each individual value document. If the security thread, to improve the stack layer, needs to be oscillated, such a design integration is impossible.

If the security paper has a recess in a security paper layer or a breakthrough, that is to say what is termed a window, security threads have still less adhesion in the substrate in these regions. The security thread can even emerge from the substrate in these regions if the adhesion to one of the layers is poor. This impairs the wet and dry foldability of the value document and therefore also the circulation stability. At the same time, counterfeiting is facilitated.

### DESCRIPTION OF THE INVENTION

It was therefore an object of the invention to provide a value document consisting of a two- or multilayer security paper having an at least partially embedded security element and a process for production thereof in which an excellent, anchoring in the substrate is provided and the further disadvantages of the prior art are avoided.

The invention therefore relates to a value document having an at least partially embedded security element, wherein the value document consists of a security paper having two or more layers of identical or different materials, characterized in that the security element is a transfer element and is applied to an internal surface of one of the layers of the security paper and is at least partially covered by at least one further layer of the multilayer security paper.

The invention further relates accordingly to providing a security element that can combine within itself a plurality of security features but is designed to be considerably thinner than a conventional security thread having the same functionality.

It is accordingly in addition an object of the invention to provide a process in which the anchoring of the security element to or in the paper layer is separated from the process of generating the multilayer security paper.

The invention therefore additionally relates to a process for producing a security paper for value documents having an at least partially embedded transfer element, characterized in that the transfer element is fed in a first step on a carrier substrate and is applied to an inner surface of a layer of the security paper with detachment of the carrier substrate and is fixed by means of an adhesive coating, and, subsequently, in one or more subsequent step(s), one or more further layer (s) are bonded to this first layer.

In the process according to the invention, the security element is applied in the form of a transfer element in a first step to one of the layers in a transfer process. The transfer element is fed to said process applied on a carrier substrate, the transfer element is contacted with the paper layer in the transfer process and transferred or applied to the paper layer with pressure and/or elevated temperature. This is taken to mean that the transfer element is fixed to the paper surface via a material bond. The carrier substrate is detached in this process so that only the transfer element remains on the paper layer. In a second step, the paper layer having the applied transfer element is bonded to the further layers.

Such a transfer element can be in the form of a strip, belt or patch. It can be continuous or interrupted or have a continuous or interrupted design. It can be visible to the naked eye, invisible, visible with the aid of auxiliaries or machine readable.

Via the variant according to the invention, a design integration in which the transfer element shall, for example, run exactly through a window, can very readily be implemented, since the thickness of the transfer element is substantially less than the thickness of a security thread according to the prior art having the same functionalities, and therefore oscillation of the security element can be dispensed with.

A further advantage of the value document according to the invention is its high resistance to manipulation. Whereas security threads which are known to consist of at least one film-type carrier substrate on which the functional layers are built up and are completely incorporated into the value document may be extricated from the composite with some skill on account of the thickness thereof and the strength of the film-type carrier substrate, with the transfer element according to the invention this is not possible, or only possible with great difficulty, since a sufficiently thick, strong film-type carrier substrate is not present and the transfer element solely consisting of the functional layers can no longer be non-destructively extricated from the composite.

The security paper can, for example, consist of a three-layer paper/plastic/paper, plastic/paper/plastic, plastic/plastic/paper, paper/paper/plastic composite, or a two-layer plastic/paper or paper/paper composite.

The individual layers consist in this case of paper, cotton paper, paper having fractions of synthetic, natural or regenerated fibers, synthetic paper, plastics, as disclosed in EP 1 599 346 A for example, natural plastics, such as, for example, PLA, modified starch, and also mixtures of the abovementioned materials, for example cotton paper or cellulose enriched with synthetic fibers for increasing the circulation stability or soiling resistance. In addition, the paper layers can contain ingredients known to those skilled in the art such as fillers, wet-strength agents, bulk and surface sizing agents. In addition, the paper layers can contain known additives for increasing the microbacteriological or virological resistance (silver ions etc.) and also security features of the most varied types (pigments, dyes, colored fibers etc.). The thickness of the paper layer(s) depends substantially on the desired total thickness and the number of paper layers in the composite. If this is, for example, a triple paper-plastic-paper composite having a total thickness of 100 μm, the thicknesses of the individual paper layers are in the range from 10 to 50 μm, preferably in the range from 20 to 40 μm.

A security element in the form of a transfer element is applied to an internal surface of one of the layers of the two- or multilayer security paper.

The transfer element can be in the form of a thread, a strip or a patch. A transfer element in the form of a thread is taken to mean a transfer element, the length of which is markedly greater than the width thereof. Typically, such transfer elements extend over the full length or width of the value document, that is to say over some centimeters, and have a width of 0.5-6 mm. Strips usually have greater widths, for instance in the range of 6-30 mm. The edges of the thread or strip are generally straight and run parallel to one another, but can also be cut to be contoured, and thus take on a serpentine-shaped course, or have wavy edges, bulges or necks at defined sites and also non-parallel, straight edges.

If required, a plurality of such transfer elements can also be present simultaneously in one value document, whereby the security against counterfeiting is further markedly increased.

If, for example, a three-layer composite consisting of paper/plastic/paper is considered, the transfer element would preferably be applied to the inside of one or the paper layers. If the transfer element has been made in the form of a thread and the paper layers are continuous on both sides, the transfer element in the finished value document is virtually indistinguishable from a conventional security thread. However, even if one of the paper layers has interruptions, with a transfer element that is visible on one side, what is termed a window thread could be simulated which occurs at intervals on certain sites at the surface of the paper.

The transfer element in this case consists of one or more functional layers, wherein the transfer element is fed to the transfer process applied on a carrier substrate. The boundary surface between the functional layers of the transfer element and the carrier substrate is configured in such a manner that detachment of the carrier substrate from the transfer element (release) is possible in the transfer process. In a conventional security thread this is not the case, since there a very good and intimate connection between the film-type carrier substrate(s) and the functional layers is particularly wanted for reasons of stability to mechanical, physical and chemical effects. The surface of the transfer element which faces away from the carrier substrate carries an adhesive coating which is activated in the transfer process with pressure and/or elevated temperature and/or radiation, and ensures the adhesive bond of the transfer element to the respective layer of the multilayer security paper. On the side of the transfer element facing the carrier substrate, or on the side of the carrier substrate facing away from the transfer element, there is no adhesive coating. In the application, the carrier substrate is detached, and so only the layer structure remains on the layer of the security paper.

The transfer element, owing to the lack of carrier substrate and therefore the low thickness, preferably does not form a self-supporting layer. Rather, the layer of the security paper on which the transfer element is applied takes over the carrying function after the application. A conventional security thread always has at least one film-type carrier substrate which before, during and also after introduction into the security paper, ensures the stability of the security element. This means that the properties such as extensibility, tear strength and puncture resistance in the transfer element according to the invention are lower than in a transfer element that is known from the prior art.

The thickness of the transfer element is given by the number and nature of the functional layers and is in the range from 3 to 25 μm, preferably in a range from 3 to 18 μm, especially preferably in a range from 6 to 18 μm.

Useful carrier substrates are carrier films, preferably flexible plastic films, for example made of PI, PP, MOPP, PE, PPS, PEEK, PEK, PEI, PSU, PAEK, LCP, PEN, PBT, PET, PA, PC, CCC, POM, ABS, PVC, PTFE, ETFE (ethylenetetrafluoroethylene), PEA (tetrafluoroethylene-perfluoropropyl vinyl ether-fluorine-containing copolymer), MFA (tetrafluoromethylene-perfluoropropyl vinyl ether-fluorine-containing copolymer), PTPE (polytetrafluoroethylene), PVF (polyvinyl fluoride), PVDF (polyvinylidene fluoride) and EFEP (ethylene-tetrafluoroethylene-hexafluoropropylene-fluorine-containing terpolymer).

The carrier substrates preferably have a thickness from 5 to 100 μm, preferably 5 to 36 μm.

To the carrier substrate is applied a first paint layer which is releasable, that is to say the adhesion thereof to the carrier substrate is less than the adhesion of the remaining layers of the transfer element to one another. With suitable selection of the carrier substrate with respect to the surface area thereof and the paint layer, a releasable paint layer can be produced without further measures.

As first paint layer, for example a thin layer based on cycloolefin copolymers, nitrocellulose, acrylates, polyvinyl chloride, ethylene acrylate copolymers or styrene acrylates in a suitable solvent are useful. For adjusting the adhesion, preferably chlorinated polyolefins are added in this case. The fraction of chlorinated polyolefins in the composition can be 0 to 130% by weight in the ratio to the base polymer. In particular, however, radiation-curable, for example UV-curable or electron-beam-curable paint layers or liquid crystal layers are also used.

Optionally, this first paint layer can also already comprise security features, such as security pigments or security dyes, for example colored, heat-sensitive, luminescent pigments or dyes, embossed microstructures or macrostructures, surface relief, diffraction gratings, diffraction structures, holograms, lens structures, Moiré structures, and the like.

If the first paint layer carries security features in the form of embossed holograms, microlenses or other surface reliefs, the first paint layer is preferably a thermoplastic embossed paint layer, for example based on PMMA, or a UV-curable embossed paint layer. Such layers and production thereof are known, for example, from EP 1 352 732 A or EP 1 310 381 A, the disclosure of which is here explicitly incorporated by reference.

The application weight of the first paint layer is 1 to 10 g/m², preferably 1 to 5 g/m².

In addition to adjusting the defined adhesion to the carrier substrate, the first paint layer also has a protective function, since, after the transfer, it lies on top and is exposed to mechanical and/or chemical and/or thermal stresses during further processing of the layer having the applied transfer element. It is therefore advantageous if the first paint layer has excellent physical and chemical resistances owing to suitable formulation of the paint.

In another embodiment, the first paint layer can be any paint layer, wherein, between this paint layer and the carrier substrate, in addition a release layer is applied. This can consist, for example, of thin wax or silicone layers and permits a targeted adjustment of the adhesion between the first paint layer and the carrier substrate in the transfer process, the release layer is detached with the carrier substrate. The application weight of such a release layer is generally below 0.5 g/m².

The transfer element can contain other mono- or multi-functional layers which are also known from familiar security elements.

In particular layers of metals, metal alloys and metal compounds applied on a complete surface or partially are useful here. As metal layer, layers of Al, Cu, Fe, Ag, Au, Cr, Ni, Zn, Sn, Pt, Ti, Pd and the like are suitable. Suitable alloys are, for example, Cu—Al alloys, Cu—Zn alloys, and the like. Suitable metal compounds are, for example, oxides or sulfides of metals, in particular TiO₂, Cr oxides, ZnS, indium-tin oxide, antimony-tin oxide, antimony-zinc oxide, FTO, ZnO, Al₂O₃ or silicon oxides. The metallic layer can be applied by a PVC or CVD process (sputtering, vapor deposition). The metal layers can be opaque or semi-permeable or be transparent in the visible and/or infrared and/or ultraviolet spectral range and have a high or low refractive index in order to be able to build up targeted optical layer systems.

Preferably, recesses in the form of letters, signs, symbols, lines, guilloché patterns, numbers or writing can be present in the metal layers, which recesses give contrast when viewed in transmitted light. Suitable processes for producing such partial metal layers are described, for example, in DE 197 39 193 A or EP 1 332 238A.

Instead of vapor-deposited metal layers, printing inks or paints with metal pigments can also be used.

In addition, the transfer element can also comprise ink and/or paint layers having optical, optically variable, magnetic or electrically conducting properties.

As ink or paint layers, in each case the most varied compositions can be used. The composition of the individual layers can vary, in particular, according to the object thereof, that is to say whether the individual layers serve exclusively decoration purposes or shall be a functional layer, or whether the layers shall be both decoration and functional layers.

These layers can be pigmented or non-pigmented. Pigments which can be used are all known pigments such as, for example, titanium dioxide, zinc sulfide, kaolin, ITO, ATO, FTC, aluminum, chromium and silicon oxides and also colored pigments. In this case, aqueous and solvent-containing paint systems can be used, just as can solvent-free or radiation-cured systems.

Preferably, the pigments are introduced into acrylate polymer dispersions having a molecular weight of 150 000 to 300 000, into acrylate-urethane dispersions, acrylate, styrene or PVC-containing dispersions, or into solvent-containing dispersions of this type.

The optical properties of the layer may be affected by visible dyes or pigments, luminescent dyes or pigments which, in the visible range, in the UV range or in the IR range are fluorescent or phosphorescent, effect pigments such as liquid crystals, pearl luster, bronzes and/or multilayer color-change pigments and photochromic, heat-sensitive dyes or pigments. These materials can be used in all possible combinations. In addition, phosphorescent pigments can also be used alone or in combination with other dyes and/or pigments.

An electrical conductive layer can be a metallic or non-metallic or polymeric conductive layer, wherein, as metallic electrically conductive layers, substantially the above-mentioned metallic layers are useful.

However, carbon black-, graphite- or silver-pigmented dispersions or solutions in ethylene acrylate copolymer, nitrocellulose, PVB, PA, acrylate or PVC or copolymers thereof can also be used.

The pigment fraction can be up to 90%, preferably the binder fraction can be 20 to 70%.

A polymeric electrically conductive layer can be formed from, for example, polyacetylene, poly-p-phenylene, polypyrrols, polythiophenes, poly-p-phenylenevinylene, low-molecular-weight macrocyclic semiconductors, organopolysilanes, polysulfur nitride and/or poly-anilines and/or derivatives thereof. Preferably, polyaniline or polythiouhenes are used as electrically conductive polymers.

The magnetic properties of a layer can be sec by paramagnetic, diamagnetic and also ferromagnetic substances, such as iron, nickel and cobalt, or compounds or salts thereof (for example oxides or sulfides) or alloys of rare earth metals such as, for example, cobalt/samarium alloys.

Particularly suitable for generating magnetic security features are magnetic pigment in containing pigments based on Fe-oxides, iron, nickel, cobalt and alloys thereof, barium or cobalt-ferrite, hard- and soft-magnetic iron and steel types in aqueous or solvent-containing dispersions. Useful solvents are, for example, isopropanol, ethyl acetate, methyl ethyl ketone, methoxypropanol and mixtures thereof.

Preferably, the pigments are introduced into acrylate polymer dispersions having a molecular weight of 150 000 to 300 000, into acrylate-urethane dispersions, acrylate, styrene, nitrocellulose or PVC-containing dispersions, or into solvent-containing dispersions of this type.

A plurality of layers having different magnetic materials can also be combined, wherein the magnetic features can have different coercivity and/or remanence. The magnetic layers can be applied on a complete surface or partially, adjacently, one above the other, partially or completely overlapping, or in various planes of the transfer element.

The above described ink or paint layers are applied using familiar coating processes to the optionally already coated carrier substrate. Examples which may be mentioned here are printing processes (intaglio printing, flexo printing, screen printing, offset printing, pad printing), dot screen or smooth roll application processes, slit die, immersion, curtain coating and extrusion coating.

In general, all possible combinations of security features in one and the same transfer element are possible and can occur not only individually but also in combination in order to combine, for example, a visually recognizable security feature and also a machine-readable, hidden security feature.

The structure can finally, or in an intermediate layer, be provided with a protective paint layer which can also be pigmented. The protective paint layer has the function that layers situated beneath are better protected against chemical and physical effects.

In the last step, an adhesive coating is applied to the transfer element. Suitable adhesive coatings are, depending on the substrate to which the transfer element is to be applied, heat- or cold-sealing adhesive coatings, self-adhesive coatings or radiation-cuable adhesive coatings.

In particular, during the application to temperature-sensitive layers of the two- or multilayer security paper, the use of a radiation-curable adhesive system is advantageous. For application to paper or paper-like layers, preferably a heat-sealing adhesive is used.

For introduction of the transfer element into the two- or multilayer security paper, the transfer element with the adhesive coating is brought into contact with an internal surface of the material that forms one layer of the value document.

The application of the transfer element can proceed in exact register laterally and/or longitudinally to optionally present further security features provided in or on a layer of the multilayer security paper, such as, for example, imprints, watermarks and the like, or to optionally present recesses in a layer.

In a particular embodiment, the transfer element is arranged in such a manner that she transfer element is visible in a recess of a layer of the security paper attached thereabove, or is visible in a perforation present.

The application of the transfer element to a layer of the security paper with detachment of the transfer element from the carrier substrate on which the transfer element is fed in a transfer process proceeds from roll to roil or from sheet to sheet with the aid of suitable commercially available application machines. Depending on the type of the adhesive coating, the application proceeds under the action of pressure and/or temperature and/or UV or electron radiation. In the transfer process, more precisely stated, the carrying function of the carrier substrate is taken over briefly by she paper layer; for the transfer element per se, then a self-supporting function is not absolutely necessary.

Owing to the detachment of the carrier substrate in the transfer operation, only the layers having the security features are firmly anchored to the inner surface of a layer of the security paper by means of the adhesive coating in the subsequent production of the multilayer security paper, no damage or change to the transfer element occurs.

The thickness of the transferred structure is <20 μm, but preferably <10 μm. This is substantially less than a commercially available security thread and is generally also substantially less than the thicknesses of the individual layers of the composite. If the transfer element is applied to a paper layer under the action of pressure and/or elevated temperature, during the transfer operation, in addition, the paper is locally compacted, for which reason, for example, a transfer element of thickness 20 μm does not lead to a local thickening of likewise 20 μm, as could be expected, but rather at best to a local thickening of <5 μm. Already owing to the low thickness of the transfer element, and in addition owing to the compaction in the transfer operation, a uniform thickness of the value document over the entire extent is ensured and does not lead to the problems mentioned at the outset during stacking or rolling up.

In order to improve further the thickness homogeneity, even before application of the transfer element, a depression can be generated, for example by calendering in the region of the later application or by deliberate thinning of a paper layer during paper production.

The application can be applied not only to a continuous layer of the security paper, but also to a layer having a perforation already generated in advance by punching, cutting or similar processes. The transfer element then bridges the opening that remains open. In addition, after the application, the layer can be punched or cut in the region of the transfer element, in such a manner that both the layer of the security paper and the transfer element itself are perforated at least in regions. As a result, the region of the window can remain completely transparent and is not disturbed by the applied transfer element.

Then, after, in a first step, the transfer element has been applied to a layer of the multilayer security paper, this layer is bonded to one or more further layers of the security paper. This operation can proceed from sheet to sheet or preferably from roll to roll. The transfer element can be applied in the same operation as the production of the multilayer security paper (in-line) or in separate working runs (off-line).

The individual layers are generally bonded in the gap between an optionally heated roller pair that subjects the composite to pressure and/or temperature. If, for one or more layers, materials are used that have a sufficiently low melting point, in such a manner that the other materials are not destroyed, the bonding process can proceed merely by the action of pressure and temperature, in such a manner that a durable bond is achieved. If there is the risk that the individual layers will be destroyed by an excessively high temperature, the process temperature can be markedly reduced by using an adhesive for bonding the layers. The adhesive can dry or cure at room temperature or become molten at markedly lower temperatures than the materials of she layers. Radiation-cured adhesives can also be used, and then the temperature stress during the bonding process is lowest.

In a preferred embodiment, the multilayer security paper is produced by what is termed an extrusion lamination of two or more layers. In this process a molten polymer is introduced by means of a slit die between two layers which generally consist of paper, the layers are united in a roller gap and then cooled. The extruded layer is then a separate layer of the security paper. Such a process is described, for example, in WO 2006/066431 A, the contents of which are hereby incorporated in their entirety by reference.

In the figures, exemplary embodiments of the value document according to the invention and of the transfer element are shown.

The reference numbers in the figures have the following meanings:
1 Value document
2 Hologram strip applied to the surface of the value document
3 Completely embedded transfer element
4 Partially visible transfer element
5, 5a, 5b Recesses in the top paper layer
6 Recess in the bottom paper layer
7 Top paper layer
8 Polymer layer
9 Bottom paper layer
10 carrier film
11 Transfer layer
12 Metallic coating
13 Adhesion promoter layer
14 Adhesive coating
15 Low-coercivity magnetic printing ink
15a High-coercivity magnetic printing ink
16 Recesses in the form of signs, codes etc.
17 Flat recess
18, 18a Paper layer with applied transfer element
19 Coating with color-shift effect
20 Fluorescent coating
21 Text printed in color
22 Electromagnetic wave-reflecting layer
23 Spacer layer
24 Layer of metallic clusters
25 Partially visible transfer element, cut so as to be contoured
26 Bulges
27 Polymer layer
28 Paper layer without transfer element
29 Roller pair

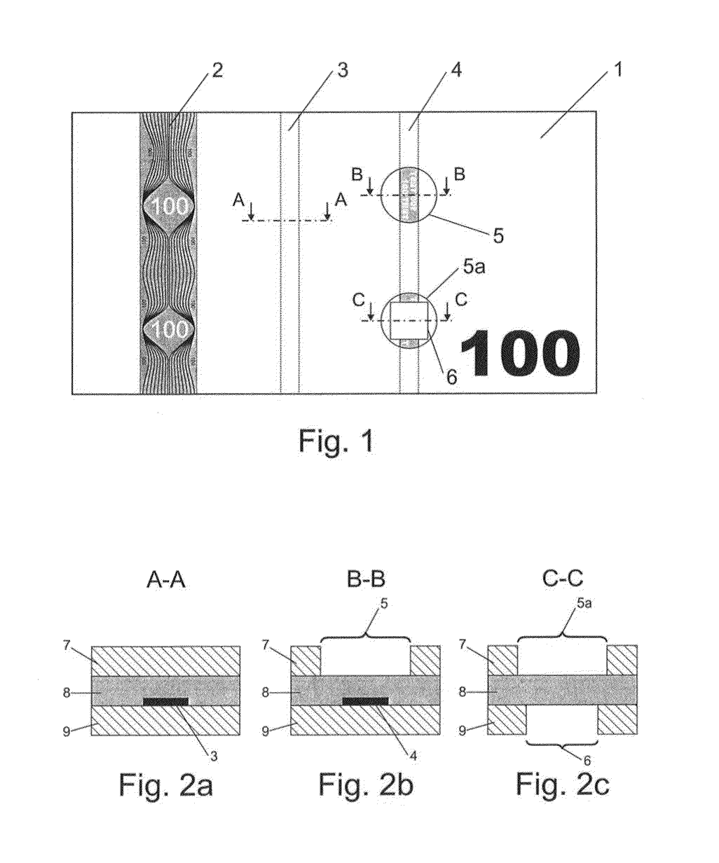

FIG. 1 shows a value document 1 according to the invention having a conventional hologram strip 2 which is applied on the outer surface of the value document. In addition, the value document shown has two transfer elements 3 and 4 which are arranged in the interior of the multilayer security paper. The transfer element 3 is completely embedded between opaque paper layers 7, 9 and is therefore only recognizable in transmitted light and not in reflected light, similar to a conventional, completely embedded security thread. The transfer element 4 is embedded in such a manner that it is visible in reflected light through a recess 5 in the top paper layer 7 at the site of the recess 5. In the region of the recess 5a, the bottom paper layer 9 together with the applied transfer element 4 is likewise perforated, and so a transparent window is formed when the polymer layer 8 consists of a transparent material.

FIG. 2a shows the region of the transfer element 3 in cross section along the dot-dashed line A-A in FIG. 1. The value document in this case consists of a top paper layer 7, a polymer layer 8 and a bottom paper layer 9. The transfer element 3 is applied to the bottom paper layer 9 and is protected on both sides by at least one paper or polymer layer. The different thickness of the bottom paper layer 9 in the region of the applied transfer element 3 is in part compensated for by a somewhat lower thickness of the polymer layer 8. Nevertheless, the total thickness of the value document 1 at the site of the introduced transfer element 3 is not significantly different to that outside this region.

FIG. 2b shows the value document in the region of the recess 5 in cross section along the dot-dashed line B-B in FIG. 1. In this case also, the value document consists of a top paper layer 7, a polymer layer 8 and a bottom paper layer 9. The top paper layer 7, however, is perforated at the site of the transfer element 4 (recess 5) for example by punching or cutting. If a transparent polymer is then used for the polymer layer 8, the transfer element 4 is visible in reflected light from the side of the top paper layer 7. From the back side, the transfer element 4 is hidden and can only be recognized in transmitted light.

FIG. 2c shows the value document in the region of the recess 5a in cross section along the dot-dashed line C-C in FIG. 1. In contrast to the situation in FIG. 2b, here the bottom paper layer 9 together with the applied transfer element 4 is also perforated in the form of a recess 6. This is achieved by the bottom paper layer 9 being punched or cut after application of the transfer element 4.

Similarly, it is conceivable that both paper layers 7 and 9 are recessed at the site of the transfer element 4, but the transfer element 4 is not and therefore bridges the recess 6. The transfer element 4 can therefore be viewed from both sides in reflected light. The recesses 5a and 6 can also be arranged offset in the top and bottom paper layer, in such a manner that the transfer element 4 is visible in reflected light at different sites both on the top side and the bottom side of the value document 1.

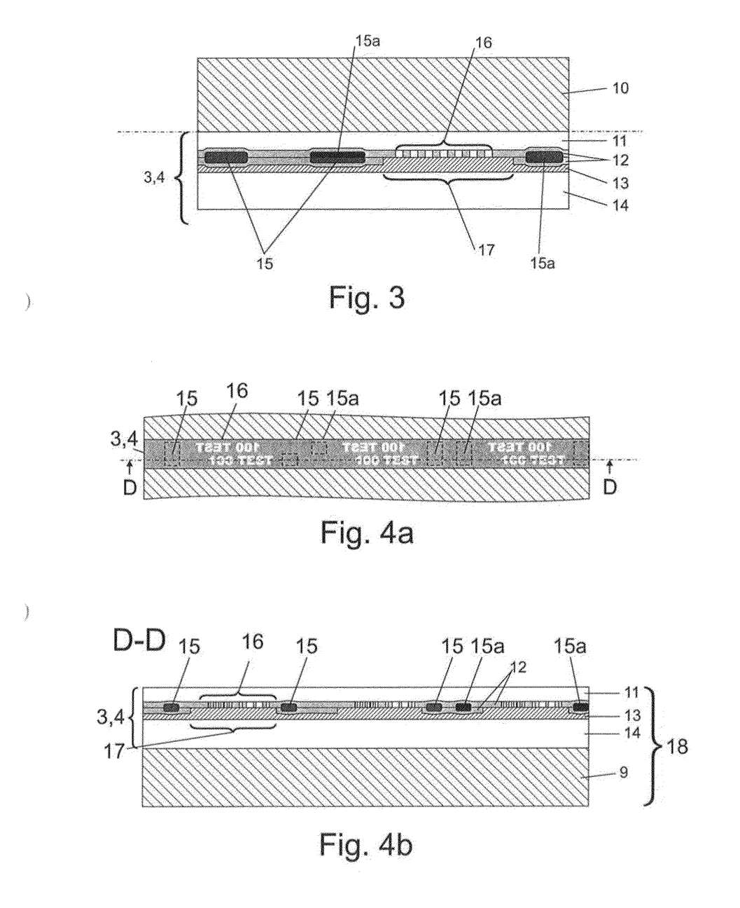

FIG. 3 shows an example structure of a transfer element 3 and 4 having optical and machine-readable security features before the application. On the carrier substrate 10 there is first situated a releasable paint layer 11. Then follows a metal layer 12 with recesses 16 in the form of negative signs, symbols, codes or similar structures recognizable in transmitted light. In the regions not provided with recesses 16, machine-readable structures, for example low-coercivity magnetic regions 15 and high-coercivity magnetic regions 15a are present. For covering the generally dark magnetic regions, thereafter a further reflecting metal layer 12 is applied which has recesses 17 that are arranged in such a manner that, in transmitted light, the recesses 16 in the first metal layer 12 remain visible. This layer sequence is protected from physical and chemical attack by a protective paint 13. Finally, an adhesive layer 14 is applied, with the aid of which the transfer element can be applied to a layer of the value document.

The situation after application of the security feature on one of the layers of the value document is shown in FIG. 4a in plan view and in FIG. 4b in cross section along the dot-dashed line D-D in FIG. 4a. The carrier substrate 10 is no longer present after the application. In the plan view, the recesses 16 in the metal layer 12 are clearly recognizable as text “TEST” and numbers “100”. The magnetic regions 15 and 15a are completely covered on both sides by the two metal layers 12 and therefore cannot be differentiated optically from the non-magnetic metalized regions, but may only be detected by suitable reading equipment. The paper layer with applied transfer element 18 is now used for producing the multilayer security paper for the value document 1.

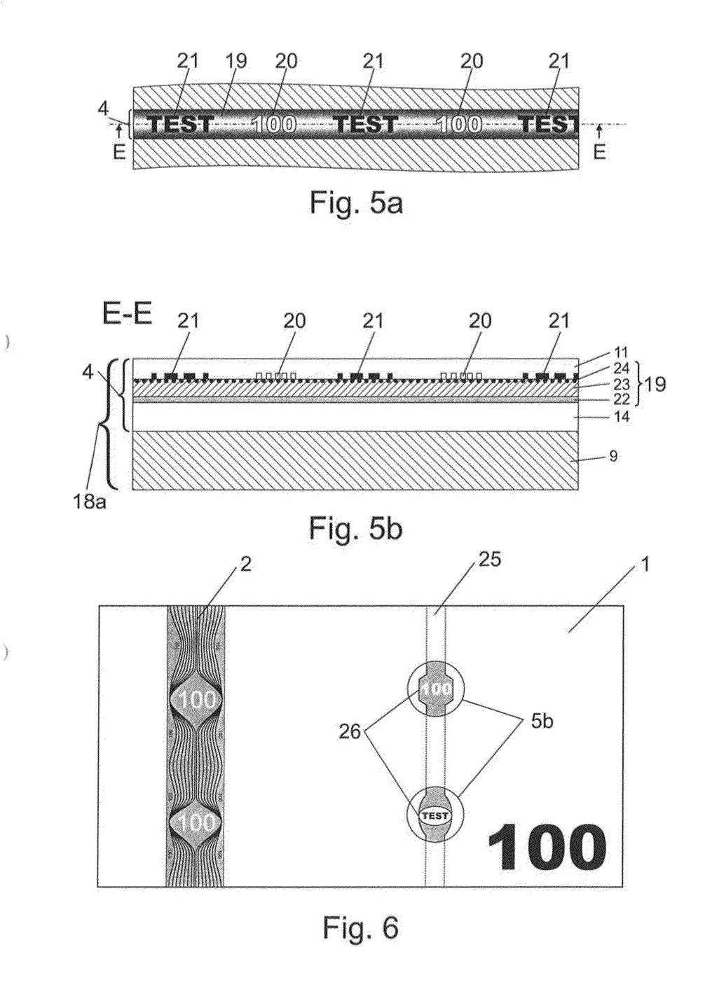

A further transfer element 4 according to the invention having optical properties that is already applied to a paper layer 9 is shown in FIG. 5a in plan view and in FIG. 5b in cross section along the dot-dashed line E-E in FIG. 5a. The transfer element 4 has three security features in the form of a coating having color-shift effect 19, a partially printed fluorescent coating 20 in the form of the text “100” and a colored microprint in the form of the text “TEST”. If the transfer element 4 is viewed under daylight conditions, at the sites at which the coating having color-shift effect 19 is visible, a different coloring dependent on the angle of view appears. Typical color transitions of such coatings change, for example, from magenta to green or from green to blue. The coating having color-shift effect 19, in the example shown in FIGS. 5a and 5b, consists of three layers: an electromagnetic wave-reflecting layer 22, a transparent spacer layer 23 and a layer of metallic clusters 24. The desired color-shift effect can be adjusted via the optical properties of the individual layers and the defined thickness of the spacer layer. Details on the mode of functioning of such layer structures may be found, for example, in EP 1 716 007 A. The printed text 21 is printed with an ink (e.g. a covering white) different to the inks of the coating having color-shift effect. The test 21 is therefore, under daylight conditions, clearly recognizable as such and does not change its color when the angle of view is changed. If the transfer element 4 is illuminated with UV radiation, the fluorescent coating 20 emits radiation in the visible spectral range. The transfer element can therefore firstly readily be verified with the naked eye via the coating having color-shift effect 19 and the microprint 21 and in addition offers a second level of security via the fluorescent coating 20, which can also be activated by lay people using simple means. Such a transfer element is particularly attractive if it is combined with a recess in one of the layers of the value document and is therefore readily visible at this site.

FIG. 6 shows a further value document 1 according to the invention which firstly comprises a hologram strip 2 applied on the outer surface and secondly a transfer element 25 which is visible in two regions through recesses 5b in the top paper layer 7. The transfer element 25 has protrusions 26 at two sites, one in square and one in elliptical form. The shape of the transfer element 25 is already established during production thereof by a contoured cutting. In the region of the recesses, visible and non-visible transfer elements can be situated. By this method, the area of the window can be utilized better, wherein, in the region in which the security feature 25 is completely embedded, again the impression of a conventional security thread is formed.

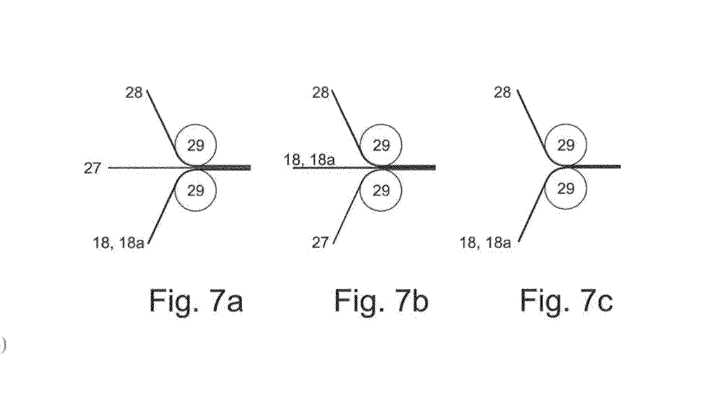

The various ways of producing the composite are shown in FIGS. 7a-7c. The paper layers having applied transfer element 18 or 18a, the polymer layer 21 and the paper layer without transfer element 22 are combined between a roller pair 29 under the action of pressure and/or temperature and/or radiation. The previously produced paper layer having transfer element 18 or 18a can then be either one of the outer layers of the composite (FIG. 7a) or the central one of the three layers of a composite (FIG. 7b). It is always important that the transfer element is situated on one of the surfaces lying within the composite. FIG. 7c shows a double composite consisting of a layer having transfer element 18 or 18a and a further layer 28.

### Example Structure 1

### Machine-Readable Transfer Element, cf. FIGS. 4a and 4b

Carrier film PET 23 μm
Transfer paint UV curing, application weight 3 g/m², releasable
Partial metallization 2.0 OD
Adhesion primer, application weight 0.5 g/m²
Low-coercivity magnetic ink, partially printed
Printing ink with metal pigments, application weight 1.5 g/m²
Heat-sealing paint, application weight 10 g/m²

### Example Structure 2

### Optically Variable Transfer Element, cf. FIGS. 5a and 5b

Carrier film PET 19 μm
Transfer paint based on a cycloolefin copolymer, 4 g/m², releasable
Partial printing with black printing ink
Partial printing with blue fluorescent printing ink Layer of aluminum clusters, nominal thickness 3 nm
Spacer layer of UV-curing paint, thickness 550 nm
Reflection layer of 2.0 OD aluminum, vapor-deposited
Heat-sealing paint, application weight 8 g/m²

### Example Structure

### Substrate Composite Having Integrated Transfer Element

Security paper having watermark, weight per unit area 35 g/m²
Transfer element applied thereto according to example 1 or 2, without carrier film
Polymer core of polyamide, thickness approximately 30 μm
Security paper having watermark, punched, weight per unit area 35 g/m²

1. A value document having an at least partially embedded security element, wherein the value document consists of a security paper having two or more layers of identical or different materials, characterized in that the security element is designed as a transfer element and is applied to an internal surface of one of the layers of the security paper and is at least partially covered by at least one further layer of the multilayer security paper.

2. The value document as claimed in claim 1, characterized in that at least one of the layers of the security paper has at least one recess.

3. The value document as claimed in claim 2, characterized in that the transfer element is situated in exact register laterally and/or longitudinally to the at least one recess and is preferably situated in at least partial overlapping therewith.

4. The value document as claimed in claim 1, characterized in that at least one of the layers of the security paper has at least one security feature.

5. The value document as claimed in claim 4, characterized in that the transfer element is situated in exact register longitudinally and/or laterally to the security feature.

6. The value document as claimed in claim 1, characterized in that the transfer element is fixed onto an internal surface of the layer of the security paper by an adhesive coating.

7. The value document as claimed in claim 6, characterized in that the adhesive coating is a heat- or cold-sealing adhesive coating, a self-adhesive coating, a hot-melt adhesive coating, or a radiation-cured coating.

8. The value document as claimed in claim 1, characterized in that the layers of the security paper consist of paper, synthetic paper, cotton paper and/or plastic.

9. The value document as claimed in claim 1, characterized in that the layer of the security paper onto which the transfer element is applied has a depression at the site of the transfer element.

10. The value document as claimed in claim 10, characterized in that the depression is generated before the application of the transfer element and/or characterized in that the depression is generated by the compaction of the layer of the security paper during the application of the transfer element.

11. The value document as claimed in claim 1, characterized in that the transfer element is made up of one paint layer and one or more complete-surface and/or partial layer(s) having functional properties, wherein the thickness of the transfer element is in a range from 3 to 25 μm, preferably in a range from 3 to 18 μm, especially preferably in a range from 6 to 18 μm.

12. The value document as claimed in claim 11, characterized in that the thin paint layer and the layer(s) having functional properties are applied to a film-type carrier substrate before the application to one of the layers of the value document.

13. The value document as claimed in claim 12, characterized in that the thin paint layer is releasable.

14. The value document as claimed in claim 12, characterized in that a release coating is arranged between the thin paint layer and the film-type carrier substrate.

15. The value document as claimed in claim 11, characterized in that the paint layer has an embossed structure.

16. The value document as claimed in claim 11, characterized in that the layer(s) having functional properties has (have) electrically conducting and/or optical and/or optically active features.

17. The value document as claimed in claim 11, characterized in layer(s) having functional properties magnetic features.

18. The value document as claimed in claim 17, characterized in that the transfer element has a plurality of layers having magnetic features made of materials having identical or different coercivity and/or remanence.

19. The value document as claimed in claim 18, characterized in that the magnetic features are applied on a complete surface or partially, adjacently, one above the other, partially or completely overlapping and/or in various planes of the transfer element.

20. The value document as claimed in claim 11, characterized in that the transfer element has a combination of plurality of security features in the form of partial and/or complete-surface layers.

21. The value document as claimed in claim 11, characterized in that the transfer element is provided with a protective plant layer.

22. A process for producing a security paper for value documents having an at least partially embedded transfer element, characterized in that the transfer element is fed in a first step on a carrier substrate and is applied to an inner surface of a layer of the security paper with detachment of the carrier substrate and is fixed by means of an adhesive coating, and, subsequently, in one or more subsequent step(s), one or more further layer(s) are bonded to this first layer.

23. The process as claimed in claim 22, characterized in that the two steps are carried out in-line or off-line.

24. The process as claimed in claim 22, characterized in that the application of the transfer element proceeds from roll to roll or sheet to sheet.

25. The process as claimed in claim 22, characterized in that the application of the transfer element proceeds in exact register to a watermark, an imprint and/or a recess in at least one of the layers of the security paper.

26. The process as claimed in claim 22, characterized in that the layers of the security paper are bonded by means of an extrusion lamination.

27. The process as claimed in claim 22, characterized in that the layers of the security paper are bonded by means of a laminating adhesive.

28. The process as claimed in claim 22, characterized in that the layers of the security paper are bonded by means of a lamination without adhesive.

29. The process as claimed in claim 22, characterized in that the production of the multilayer composite proceeds under the action of pressure and/or temperature and/or UV radiation or electron radiation.
